(19) United States
(12) Patent Application Publication
(10) Pub. No.: US 2008/0224429 A1
(43) Pub. Date: Sep. 18, 2008

(54) Toboggan for use on wet sand

(76) Inventor: Jennifer Watson, Hanover, MA (US)

Correspondence Address: Russ Weinzimmer, 614 Nashua St. #204, Milford, NH, 03055, US

(21) Appl. No.: 11/717,965

(22) Filed: Mar. 14, 2007

(51) Int. Cl. B62B 15/00

(52) U.S. Cl. 280/19

(57) ABSTRACT

An apparatus and method are disclosed that enable towing a least one seated person across wet sand, typically but not exclusively for recreational purposes, such as at a beach. The apparatus includes a platform with at least one seat installed, and with a towing means, such as a cord or a rod, attached to the front. The bottom surface of the platform provides low friction when placed on wet sand. The at least one seat is either inflatable or foam-filled. Preferably, handles and/or seat belts are provided. In some embodiments, an attachment point is provided at the rear of the platform so as to allow attachment to the front of a second platform, thereby forming a chain of platforms that can be towed as a group. Additional entertainment and convenience items can also be attached to the platform, such as a cup holder, a carrying basket, or a toy horn.

### FIELD OF THE INVENTION

The invention generally relates to recreational devices used at a waterfront, and more specifically to devices that slide across wet sand.

### BACKGROUND OF THE INVENTION

Sliding devices such as sleds and toboggans that carry people across low friction surfaces are well known, and are considered to be sometimes practical and often enjoyable to use. In the case of snow and ice covered surfaces, sleds and toboggans can be used to slide down hills under the force of gravity, or they may be towed across flat areas using a rope, rigid handle, or other suitable towing means. For example, the practice of parents towing their children on sleds or toboggans across frozen lakes has been well known for centuries. In some instances, depending on the needs and preferences of the passengers, seats and handles are included on the sled or toboggan to provide for greater comfort and stability.

Wet sand, as found at the water's edge at a seashore or lake beach, provides another example of a low friction surface. However, there are few if any known devices that apply the principles of a sled or a toboggan to this environment. A skim board travels across wet sand, but a skim board is not designed to be towed, nor does it include any features intended to accommodate a seated passenger. Furthermore, successful use of a skim board requires an advanced degree of skill and balance, since the rider must step onto the board while running and then stand on it while riding.

### SUMMARY OF THE INVENTION

A general aspect of the invention is an apparatus for enabling at least one standing person to tow at least one sitting person across wet sand. The apparatus includes a platform having a front end and a back end, the platform having sufficient strength and stiffness to bear the weight of the at least one sitting person without undue deformation, the platform having a bottom surface for gliding over wet sand, and the platform being shaped such that it resists tipping over during towing across the wet sand. The apparatus also includes at least one seat attached to the platform for supporting the at least one sitting person; and a towing extension, attached to the front end of the platform, the towing extension being for allowing the at least one standing person to transmit a pulling force to the front end of the platform sufficient to pull the platform and the at least one sitting person across the sand.

In preferred embodiments, the platform includes a core of substantially rigid plastic foam. In further preferred embodiments, the substantially rigid plastic foam is made from one of polyethylene foam or polypropylene foam. In other further preferred embodiments, the platform includes a bottom coating of plastic capable of providing substantially low friction when pulled over wet sand, and capable of substantially resisting impact and abrasion. In still further preferred embodiments, the platform includes a coating of Surlyn®.

In other preferred embodiments, the platform includes a core of skim board material. In still other preferred embodiments, the platform includes epoxy fiberglass.

In some preferred embodiments, the platform includes a top layer of soft foam.

In other preferred embodiments, the towing extension includes a flexible cord. In alternate preferred embodiments, the towing extension includes a substantially rigid rod. In further preferred embodiments, the towing extension includes at least one handle to be grasped by the standing person.

In preferred embodiments, the at least one seat is inflatable. In other preferred embodiments, the at least one seat is filled with plastic foam.

In some preferred embodiments, at least one seat belt is provided to ensure that the at least one sitting person remains in the at least one seat.

In additional preferred embodiments, at least one pair of handles is attached to the platform on a right side and a left side of the at least one seat for grasping by the at least one sitting person.

In still additional preferred embodiments, at least one of a cup holder, a carrying basket, a toy horn, and other convenience and entertainment devices are attached to the platform within reach of the at least one rider.

In preferred embodiments, the at least one seat includes a suitable combination of slope, elevation, drain ports, and other drainage means that prevent significant amounts of water from accumulating in the seat when the seat is splashed with water.

In some preferred embodiments, an attachment means is provided at a back end of the platform, the attachment means being for attaching a front end of a second platform, thereby forming a chain of platforms that can be towed as a group.

In other preferred embodiments, the platform includes two seats attached to the platform.

Another general aspect of the invention is a method for towing at least one sitting person across wet sand. The method includes providing a platform having a front end and a back end, the platform having sufficient strength and stiffness to bear the weight of the at least one sifting person without undue deformation, the platform having a bottom surface for gliding over wet sand, and the platform being shaped such that it resists tipping over during towing across the wet sand; at least one seat attached to the platform for supporting the at least one sitting person; and a towing extension, attached to the front end of the platform, the towing extension being for allowing the at least one standing person to transmit a pulling force to the front end of the platform sufficient to pull the platform and the at least one sitting person across the sand. The method also includes placing the platform on wet sand; positioning the at least one sitting person in the at least one seat; grasping the towing extension; and pulling on the towing extension with sufficient force to cause the platform to move across the wet sand.

### BRIEF DESCRIPTION OF THE DRAWINGS

FIG. 1 is a perspective view from the left side showing the invention in use by a child;

FIG. 2 is a perspective view of the invention from a point near the front;

FIG. 3 is a perspective view from the left side of an embodiment that includes two seats on a single platform;

FIG. 4 is a perspective view from the left side showing two identical platforms connected front-to-rear, forming a chain that may be towed as a unit; and

FIGS. 5A, 5B, and 5C show cross sectional views of sections of the platform showing typical fastening means for attaching seats, handles, and anchor points.

### DETAILED DESCRIPTION OF PREFERRED EMBODIMENTS

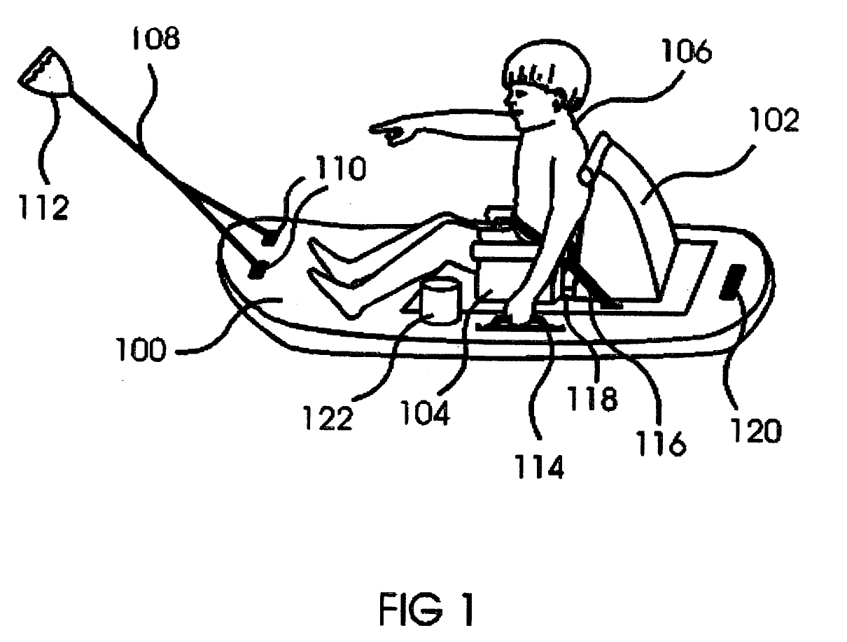

With reference to FIG. 1, the apparatus of the invention includes a platform 100 to which at least one seat is attached having a back 102 and sides 104. The platform 100 is made from materials (explained further below) that provide sufficient strength to bear the weight of the passenger 106 (such as a child), without undue flexing, and the bottom surface of the platform 100 provides low friction between the platform and wet sand.

One end of a towing means 108, such as a flexible cord or towing rod, is attached to one or more anchor points 110 at the front of the platform 100. In the preferred embodiment shown in FIG. 1, a towing handle 112 is attached to the other end of the towing means 108 to facilitate grasping by a standing person (not shown) while towing the platform 100.

In the preferred embodiment shown in FIG. 1, handles 114 are provided near the sides of the seat 104 that may be grasped by a sitting person 106 while riding the platform 100, and a seat belt 116 is attached to the platform 100 near the seat in a suitable manner to secure a sitting person 106 to the seat.

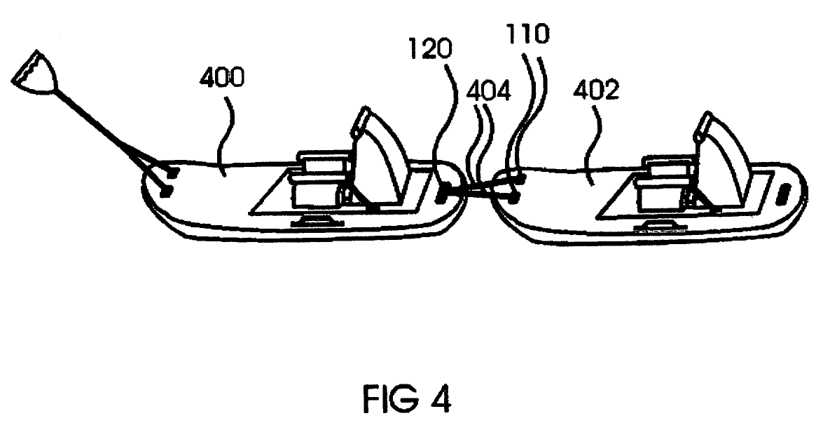

In a further preferred embodiment, drainage means are provided, such as elevation of the seat and a gap 118 between the back 102 and the sides 104 of the seat, in order to ensure that a significant amount of water does not accumulate in the seat if it is splashed, for example, by a wave at the seashore. In still another preferred embodiment, an anchor point 120 is provided at the back end of the platform in order to allow the front of a second platform to be attached, as described in more detail below with reference to FIG. 4.

In yet another preferred embodiment, additional entertainment and/or convenience items, such as a cup holder 121, a carrying basket (not shown), or a toy horn (not shown) are attached to the platform within reach of the rider.

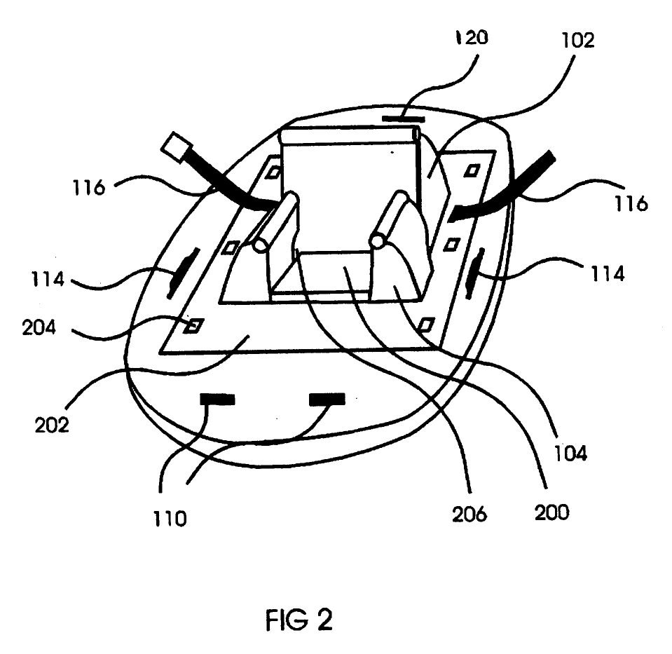

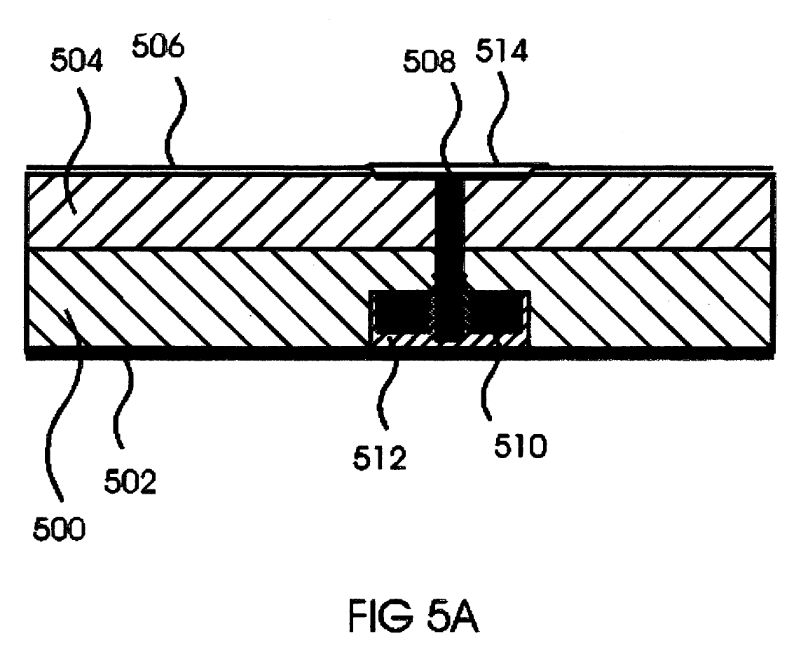

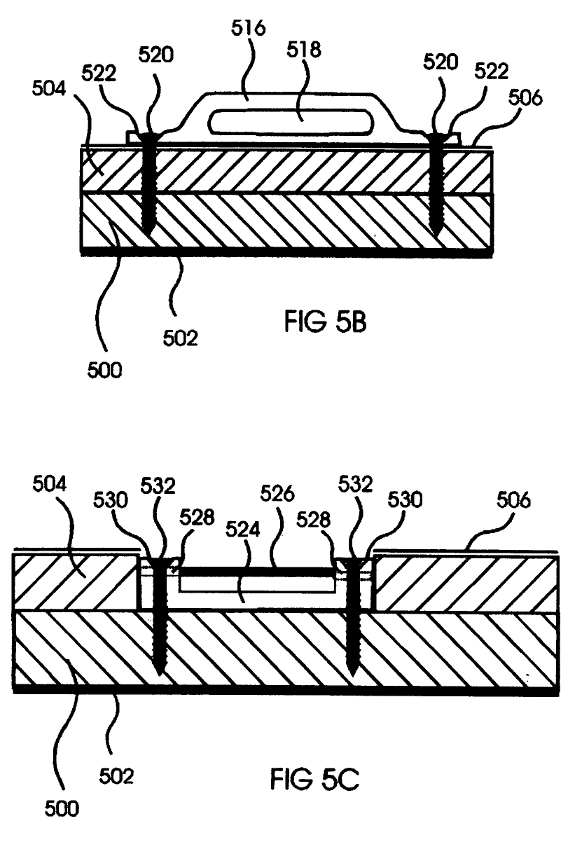

FIG. 2 shows a perspective front view of an embodiment of the invention wherein the seat 104 is inflatable. For clarity of view, the towing means is not shown. The back 102 and sides 104 of the seat are manufactured from PVC or a similar material, and communicate with each other through the seat cushion 200 and the upper portions of the sides 102, forming a single air space. All parts of the seat are glued to a single sheet of plastic 202, also made from PVC or a similar material, and the sheet of plastic is fixed to the platform of the invention by fastening means such as glue or the screw and nut means 204 described in more detail below in reference to FIG. 5A. In the preferred embodiment of FIG. 2, six screw and nut attachment points 204 are used around the perimeter of the plastic sheet to attach it to the platform, as well as one behind the seat (not shown) and one directly under the seat (not shown). The seat cushion 200 is slightly raised above the top surface of the platform, and gaps 206 are included between the back of the seat and the lower portions of the sides so that water will drain away from the seat if it is splashed.

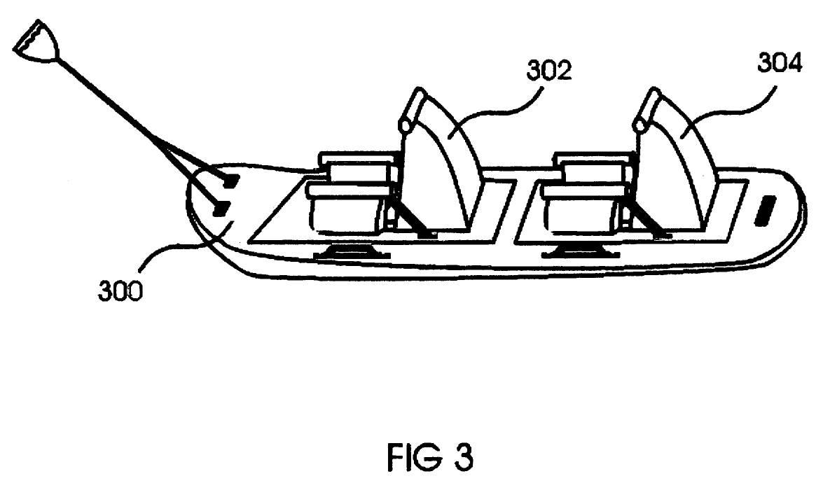

FIG. 3 is a perspective side view of a preferred embodiment of the invention that includes an elongated platform 300 with two seats 302 and 304 attached to it, allowing two sitting persons to be towed simultaneously. The seats 302 and 304 are otherwise identical to the seats described above with reference to FIG. 1 and FIG. 2.

FIG. 4 is a perspective side view showing two platforms 400 and 402 connected together to form a chain that may be towed as a single unit. One end of a suitable connecting cord or rod 404 is attached to the front of the rear platform 402 using the anchor points 110 provided for the attachment of a towing means. The other end of the connecting cord or rod 404 is attached to the rear of the front platform 400 using the anchor point 120 provided for this purpose.

With reference to FIG. 5A, in a preferred embodiment the platform consists of a core 500 of semi-rigid plastic foam such as polyethylene foam, polypropylene foam, or other closed-cell thermoplastic olefinic foam material. A bottom coating 502 made of Surlyn®, or other slick plastic coating that provides substantial impact toughness and abrasion resistance, is glued or heat bonded to the bottom of the core 500, providing additional strength and low friction on wet sand. In another preferred embodiment (not shown), the core 500 is made from an epoxy fiberglass composite that provides both strength and low friction, thereby eliminating the need for a bottom coating. Alternatively, a bottom coating, such as Surlyn®, can be adhered to the bottom of a core 500 made from epoxy fiberglass or other suitable skim board material.

In yet another preferred embodiment, a layer of soft plastic or foam 504 is glued to the top surface of the core 500, and provides enhanced comfort and safety of the rider 106.

In a further preferred embodiment, the seat of FIGS. 1 and 2 is made from PVC or a similar material, and is either inflatable or foam-filled. The seat is glued to a plastic sheet 506, also made from PVC or a similar material, that is attached to the core 500 either by gluing or by screw and nut, or similar attachment means, at a plurality of attachment points. In the embodiment shown in FIG. 5A, each attachment point consists of a plastic screw with a wide, flat head 508. The screw penetrates through a reinforced hole in the plastic sheet 506, and through holes in the soft foam top layer 504 and core layer 500 of the platform. Coaxial with the holes, the core layer of the platform 500 is countersunk from below to provide space for a plastic nut 510 to be threaded onto the screw, and after assembly of the screw 508 and nut 510 the countersunk space is filled with epoxy 512 to eliminate the void and to prevent the nut from loosening. The epoxy is sanded flush with the thick plastic bottom surface and/or covered by the slick plastic bottom coating 502.

In the preferred embodiment shown in FIG. 5A, tightening of the nut 510 causes the wide, flat head of the screw 508 to sink into the upper layer of soft foam 504 to a depth at least equal to the thickness of the wide, flat head. A flap of plastic material 514 is glued along one edge to the plastic sheet 506 and attached by Velcro along the other three edges so as to cover the head of the screw, providing a surface that is nearly flush with the plastic sheet. A thin layer of soft foam is glued to the under side of the flap (not shown) to further pad the top of the screw 508 when covered by the flap.

In preferred embodiments that do not include the upper layer of soft foam 504, the top of the core 500 is countersunk in a suitable manner to cause the top of the plastic screw to be flush with the upper surface of the core 500 and the screw is covered in a similar manner.

With reference to FIG. 5B, in a preferred embodiment substantially rigid plastic handles 516 are provided for the convenience of the passenger 106 while sitting in the seat on the platform 100. Each handle 516 includes a typical opening 518 that is large enough to allow the user's fingers to wrap around the handle. In the preferred embodiment illustrated in FIG. 5B, the handle 516 is attached to the platform 100 using two flathead screws 520 made from stainless steel or other suitable, non-corroding material. The screws 520 are essentially identical in form to standard flathead wood screws. The screws 520 pass through suitably counter-sunk holes 522 in the handle 516, through the plastic sheet 506, through the upper layer of soft foam 504 (if present), and are firmly threaded into the semi-rigid core 100. Loctite®, or a similar glue or other fixing means, is used to prevent the screws from working loose while the platform is in use.

With reference to FIG. 5C, in a preferred embodiment, anchor points for attaching towing cords or rods, seat belts, and multi-platform connections are constructed from strong, rigid plastic, or from a suitable non-corroding metal such as aluminum or brass. Each anchor point includes a U-shaped body 524 with rectangular cross-section and an anchor rod 526 inserted horizontally through the uprights of the U-shaped body 524 through holes 528 drilled through the uprights for this purpose. The anchor point is set into a rectangular hole cut into the soft foam upper layer 504 and the plastic sheet 506 of the platform 100, and rests on the top surface of the semi-rigid core 500. The U-shaped body 524 of the anchor point is sized such that when it is installed in the rectangular hole the top of the U-shaped body 54 is slightly below the level of the top of the foam upper layer 504 and the plastic sheet 506, thereby providing an anchor point that does not protrude above the top surface of the platform.

Vertical holes 530 are drilled through the uprights of the U-shaped body 524 and countersunk as appropriate for flathead screws 532. The screws 532 are made from stainless steel, brass, or another suitable non-corroding material, and are essentially identical in form to standard wood screws. The screws 532 pass through the holes 530 in the uprights and are threaded into the semi-rigid core 500. Loctite E or a similar glue or other fixing means, is used to prevent the screws from working loose while the platform is in use. Due to their locations, the screws 532 prevent the anchor rod 526 from sliding into the holes 528 that were used to install it, and thereby keep the anchor rod 526 centered in the U-shaped body 524. Cords, seat belts, and other connecting means as needed, are attached to the anchor points by passing them through the void that separates the anchor rod 526 from the U-shaped body 524 of the anchor point and wrapping them around the anchor rod 526.

In other preferred embodiments, for example, in embodiments that do not include the upper layer of soft foam 504, anchor points are essentially identical in material, shape, and attachment means to the handles described above in reference to FIG. 5B.

Other modifications and implementations will occur to those skilled in the art without departing from the spirit and the scope of the invention as claimed. Accordingly, the above description is not intended to limit the invention except as indicated in the following claims.

What is claimed is:

1. An apparatus for enabling at least one standing person to tow at least one sitting person across wet sand, the apparatus comprising:
a platform having a front end and a back end, the platform having sufficient strength and stiffness to bear the weight of the at least one sitting person without undue deformation, the platform having a bottom surface for gliding over wet sand, and the platform being shaped such that it resists tipping over during towing across the wet sand;
at least one seat attached to the platform for supporting the at least one sitting person; and
a towing extension, attached to the front end of the platform, the towing extension being for allowing the at least one standing person to transmit a pulling force to the front end of the platform sufficient to pull the platform and the at least one sitting person across the sand.

2. The apparatus of claim 1, wherein the platform includes a core of substantially rigid plastic foam.

3. The apparatus of claim 2, wherein the substantially rigid plastic foam is made from one of polyethylene foam or polypropylene foam.

4. The apparatus of claim 2, wherein the platform includes a bottom coating of plastic capable of providing substantially low friction when pulled over wet sand, and capable of substantially resisting impact and abrasion.

5. The apparatus of claim 2, wherein the platform includes a coating of Surlyn®.

6. The apparatus of claim 1, wherein the platform includes a core of skim board material.

7. The apparatus of claim 1, wherein the platform includes epoxy fiberglass.

8. The apparatus of claim 1, wherein the platform includes a top layer of soft foam.

9. The apparatus of claim 1, wherein the towing extension includes a flexible cord.

10. The apparatus of claim 1, wherein the towing extension includes a substantially rigid rod.

11. The apparatus of claim 1, wherein the towing extension includes at least one handle to be grasped by the standing person.

12. The apparatus of claim 1, wherein the at least one seat is inflatable.

13. The apparatus of claim 1, wherein the at least one seat is filled with plastic foam.

14. The apparatus of claim 1, wherein at least one seat belt is provided to ensure that the at least one sitting person remains in the at least one seat.

15. The apparatus of claim 1, wherein at least one pair of handles is attached to the platform on a right side and a left side of the at least one seat for grasping by the at least one sitting person.

16. The apparatus of claim 1, wherein at least one of a cup holder, a carrying basket, a toy horn, and other convenience and entertainment devices are attached to the platform within reach of the at least one rider.

17. The apparatus of claim 1, wherein the at least one seat includes a suitable combination of slope, elevation, drain ports, and other drainage means that prevent significant amounts of water from accumulating in the seat when the seat is splashed with water.

18. The apparatus of claim 1, wherein an attachment means is provided at a back end of the platform, the attachment means being for attaching a front end of a second platform, thereby forming a chain of platforms that can be towed as a group.

19. The apparatus of claim 1, wherein the platform includes two seats attached to the platform.

20. A method for towing at least one sitting person across wet sand, the method comprising:
providing a platform having a front end and a back end, the platform having sufficient strength and stiffness to bear the weight of the at least one sitting person without undue deformation, the platform having a bottom surface for gliding over wet sand, and the platform being shaped such that it resists tipping over during towing across the wet sand; at least one seat attached to the platform for supporting the at least one sitting person; and a towing extension, attached to the front end of the platform, the towing extension being for allowing the at least one standing person to transmit a pulling force to the front end of the platform sufficient to pull the platform and the at least one sitting person across the sand;
placing the platform on wet sand;
positioning the at least one sitting person in the at least one seat;
grasping the towing extension; and
pulling on the towing extension with sufficient force to cause the platform to move across the wet sand.
